(19) United States
(12) Patent Application Publication
(10) Pub. No.: US 2006/0037434 A1
(43) Pub. Date: Feb. 23, 2006

(54) Monodispersable magnetic nanocolloids having an adjustable size and method for the production thereof

(75) Inventors: Helmut Bonnemann, Essen (DE); Werner Brijoux, Oberhausen (DE); Rainer Brinkmann, Mulheim an der Ruhr (DE); Nina Matoussevitch, Mulheim an der Ruhr (DE); Norbert Waldofiner, Schonow (DE)

Correspondence Address: NORRIS, MCLAUGHLIN & MARCUS, PA, 875 THIRD AVENUE, 18TH FLOOR, NEW YORK, NY, 10022, US

(73) Assignee: STUDIENGESELLSCHAFT KOHLE mbH, MULHEIM an der RUHR (DE)

(21) Appl. No.: 10/518,703

(22) PCT Filed: Apr. 12, 2003
(86) PCT No.: PCT/EP03/03814

§ 371 Date: Dec. 20, 2004

(30) Foreign Application Priority Data
Jun. 21, 2002 (DE) 102 27 779.6

(51) Int. Cl. H01F 1/06

(52) U.S. Cl. 75/348; 75/362; 148/300

(57) ABSTRACT

The invention relates to monodispersable, optionally magnetic particles containing one or more metals, optionally, protected by a secondary treatment with air, having an adjustable average particle size of between 2 and 15 nm and a narrow distribution of particle size with a standard variance of 1.6 nm at the most. The invention also relates to a method for the production of said materials. Said materials are used in an isolated form or dispersed in a solution inter alia as a sealing medium against dust and gas in magnetic fluid sealing systems (liquid O-ring) for the lubrication and bearing of rotating shafts (magnetic levitation bearings), for the magneto-optical storage of information and additionally, for the magnetic marking of cells and the separation thereof in biological samples or for the local application of medicaments.

The present invention relates to novel, monometallic and polymetallic, magnetic colloid particles (e.g. Fe, Co, Fe/Co) having a mean particle size adjustable without a separation step (such as, for example, magnetic separation) between 2 nm and about 15 nm and a narrow distribution of the particle sizes (standard deviation not more than 1.6 nm), and a process for the preparation thereof. The advantage of the novel materials lies in their high saturation magnetization and in their particular suitability for the preparation of highly efficient ferrofluids having a low metal concentration and low viscosity.

Magnetic nanocolloids are sought-after materials for the production of magnetofluids. These are used in industry as a sealing medium against dust and gases in magnetic fluid seals (liquid O-ring), for lubricating and supporting rotating shafts (magnetic levitation bearings) and for magneto-optical information storage. Applications in the medical-pharmaceutical sector are, for example, magnetic markers for diseased cells and magnetic cell separation in biological samples, and furthermore local application of medicaments.

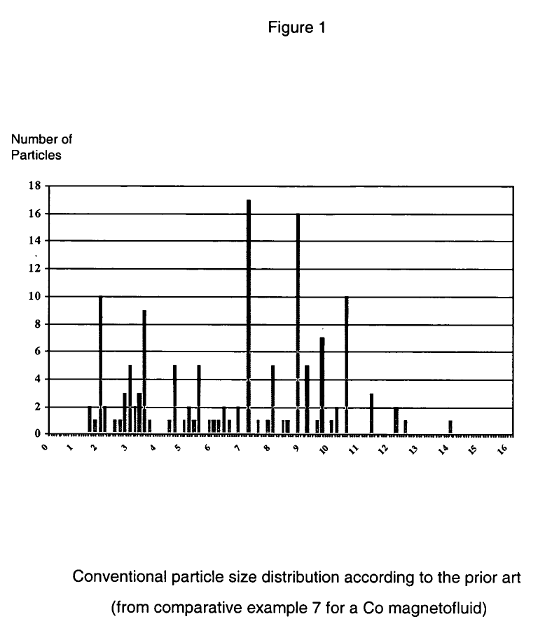

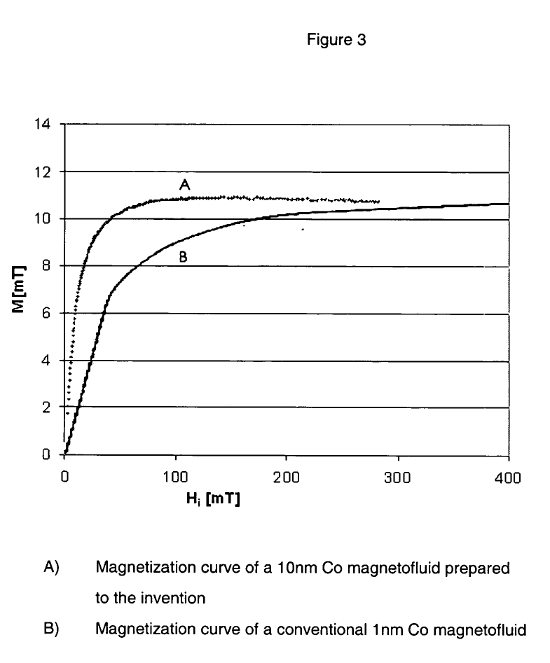

To date, only insufficient monodispersity of the nanoscopic magnetic particles was achieved by conventional preparation methods (FIG. 1). This deficiency leads to a magnetization of the conventional material which is unsatisfactory for many applications (curve B in FIG. 3). Where monodisperse magnetic particles can be produced by special methods [V. F. Puntes, K. Krishman and A. P. Alivisatos, Topics in Catalysis, 19, 145, 2002], the low yield is unsatisfactory for practical applications.

Various processes are known for the preparation of colloidal magnetic metals, in particular of nanoscopic Fe, Co and Ni, for example salt reduction (G. Schmid (Ed.), Clusters and Colloids, VCH, 1994, EP 423 627, DE 4443 705 and U.S. Pat. No. 5,620,584), thermal, photochemical and sonochemical decomposition of metal carbonyls and nitrosyl complexes [K. S. Suslick, T. Hyeon, M. Fang, A. A. Cichowlas in: W. Moser (Ed.), Advanced Catalysts and Nanostructured Materials, Chapter 8, page 197, Academic Press, 1996; V. Bastovoi, A. Reks, L. Suloeva, A. Sukhotsky, A. Nethe, H.-D. Stahlmann, N. Buske and P. Killat, Conference Material: 8th ICMF Timisoara (1998)] and the reduction of salts or the decomposition of carbonyl compounds in micellar solutions (O. A. Platonova, L. M. Bronstein, S. P. Solodovnikov, I. M. Yanovskaya, E. S. Obolonkova, P. M. Valetsky, E. Wenz, M. Antonietti, Colloid Polym. Sci. 275, 1997, 426). However, these methods always lead to nanoscopic magnetic metal colloids having a broad particle size distribution (cf. FIG. 1). These are suitable only to a limited extent for the abovementioned applications because a broad particle size distribution in the case of magnetic material permits only insufficient magnetization, i.e. the slope of the magnetization curve is too small for practical purposes (B in FIG. 3).

There has been no lack of attempts to produce magnetofluids having high saturation magnetization for industrial applications. It is true that T. Händel, H.-D. Stahlmann, A. Nethe, J. Müller, N. Buske and A. Rehfeld (PCT/DE97/00443) were able, by the use of special, corrosion-inhibiting surfactants and concentration of the dispersion obtained, to prepare a magnetofluid which has up to 35% concentration by volume of ferromagnetic component and has a saturation magnetization of >100 mT; however, this synthesis route by no means leads to magnetic particles having the desired monodispersity. Moreover, magnetofluids have to be used in high concentrations and therefore result in very viscous ferrofluids. Another route for obtaining monodisperse Co particles having a narrow size distribution from dispersions having high saturation magnetization was taken by M. Hilgendorff, B. Tesche and M. Giersig (Aust. J. Chem. 2001, 54, pages 497-501), using magnetic separation. By means of this method, Co colloids having a broad size distribution are first obtained, from which a certain range has to be filtered out by magnetic separation. Consequently, the yield of desired material was very low. According to C. Petit, A. Taleb and M. P. Pileni (J. Phys. Chem. B, Vol. 103 (11), 1999, pages 1805-1810), monodisperse Co colloid particles are obtained by reduction of Co salts in inverse micelles with NaBH₄. However, this material is highly contaminated with boron compounds and therefore not very suitable for industrial use. WO 99/41758 describes monometallic and polymetallic magnetic colloid particles having a size up to 20 nm, whose surface is protected from corrosion by means of noble metals. However, this invention relates exclusively to the anticorrosive treatment of prepared magnetic metal colloids. The preparation of the magnetic metal particles used for this purpose was effected exclusively by known processes.

It was an object of the present invention to prepare monodisperse, magnetic nanocolloids of adjustable size without an additional separation step (such as, for example, centrifuging or magnetic separation), from which nanocolloids dispersions of high saturation magnetization for said applications can be produced using dispersants.

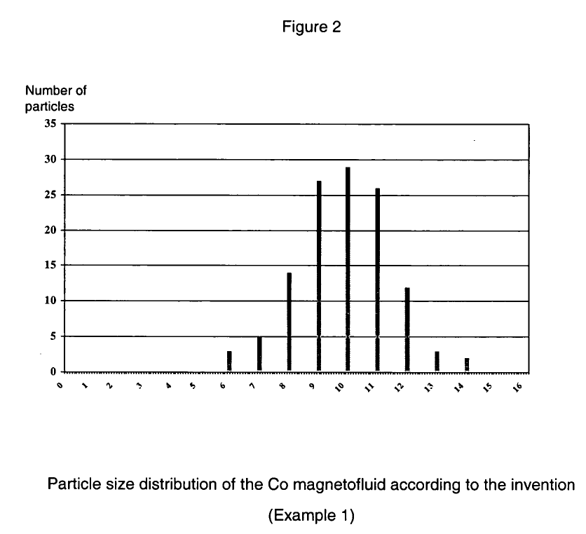

It has now surprisingly been found that magnetic nanocolloids having a very narrow size distribution (standard deviation according to TEM (transmission electron microscopy)=not more than 1.6 nm) whose mean particle size is adjustable between 2 nm and about 15 nm, but at least up to about 10.5 nm, are obtained (cf. FIG. 2) by decomposition, for example by thermolysis, photolysis or sonochemical decomposition, of low-valency compounds, such as metal carbonyl or metal olefin compounds, of metals suitable for the formation of ferromagnetic particles, e.g. Fe, Co or Ni, in the presence of an organometallic compound of metals of group 13, such as, for example, trialkylaluminum or alkylaluminum hydride compounds. The magnetization curve (A in FIG. 3) of a dispersion of 10 nm cobalt particles, prepared according to the invention, shows a magnetization of 11.6 mT at a concentration of only 0.6% by volume of cobalt. The establishing of the mean particle size is controlled by the alkyl radical and the concentration of the organometallic compound. If mixtures of low-valency compounds of different metals are used, polymetallic magnetic particles (alloy particles) form.

At in each case the same molar Co:Al ratio of about 10:1, the thermolysis of Co carbonyl gives a Co particle size of 10 nm in the presence of Al(C₈H₁₇)₃, one of 6 nm in the presence of Al(C₂H₅)₃ and one of 3.5 nm in the presence of Al(CH₃)₃. If, in the case of Al(C₈H₁₇)₃, the molar Co:Al ratio in the batch is changed from 12:1 to 0.5:1, the particle size decreases from 10 to 5.4 nm.

The isolated, monodisperse, magnetic nanocolloids prepared by this process do not have long-term stability in air but can easily be protected from total oxidation by an aftertreatment. If, before the isolation, the magnetic particles are aftertreated in organic solvent by passing over or passing through air, magnetic particles which are resistant to oxidation after drying are obtained. Thus, for example, cobalt particles which were prepared from Co₂(CO)₈ in the presence of Al(C₈H₁₇)₃ in toluene could be protected from oxidation by aftertreating the reaction mixture by passing through air. The Co particles then obtained after isolation could be handled in air and were protected from oxidation.

The magnetic nanoparticles of optionally from 2 nm to 15 nm, but at least up to 10.5 nm, in size, which are unprotected or protected by aftertreatment, can be used in isolated form or can be brought into colloidal solution with the aid of dispersants (e.g. Korantin SH from BASF or Sarcosyl from Merck) and further used in the form of magnetofluids. Without intending to restrict their applications thereby, the following examples may be mentioned: sealing medium against dust and gases in magnetic fluid seals (liquid O-ring), lubrication and support of rotating shafts (magnetic levitation bearings) and magneto-optical information storage, for example in compact disks and minidisks. After application of a cell-compatible layer (e.g. gold, cf. WO 99/41758) to the particle surface, they are furthermore suitable for magnetic in vitro marking of cells and can be used for the magnetic separation of marked cells in biological samples or for local application of medicaments. The monodispersity of the magnetic nanoparticles prepared according to the invention has a decisive advantage for all applications.

The examples which follow explain the invention without restricting them:

### EXAMPLES

### Example 1

### Co Colloids of Uniform Size (10 nm) by Thermolysis of Co₂(CO)₈ in the Presence of Al(C₈H₁₇)₃ (Atomic Co:Al=12:1)

A solution of 0.73 g=0.88 ml (1.435 mmol) of Al(C₈H₁₇)₃ in 300 ml of toluene was added to 3 g (17.55 mmol of Co) of solid Co₂(CO)₈ under an inert gas atmosphere (argon) in a 500 ml flask at room temperature. The resulting solution was refluxed for 4 h at 110° C. with stirring (not magnetic stirring), and the bath temperature was then increased to 150° C. for 1 h. A clear solution and a virtually black precipitate formed thereby with evolution of gas and a deep brown discoloration. The reaction mixture was stirred for a further 16 h while cooling to room temperature, and the supernatant solution was decanted from the precipitate. The reaction is complete when no further evolution of gas is observable. 2 ml (1.77 g, 5 mmol) of the dispersant Korantin SH (from BASF) in 50 ml of toluene were added to the remaining residue (Co particles), a completely clear, deep black-brown Co magnetofluid being obtained. It contains 67.85% by weight of Co and 0.98% by weight of Al and has a particle size of 10 nm±1.1 nm (cf. FIG. 2).

### Example 2

### Co Colloids of Uniform Size (6 nm) by Thermolysis of Co₂(CO)₈ in the Presence of Al(C₂H₅)₃ (Atomic Co:Al ratio 10:1)

A solution of 0.228 g=0.3 ml (2 mmol) of Al(C₂H₅)₃ in 300 ml of toluene was added to 3.4 g (20 mmol of Co) of solid Co₂(CO)₈ under an inert gas atmosphere (argon) in a 500 ml flask at room temperature. The resulting solution was refluxed for 4 h at 110° C. with stirring (not magnetic stirring), and the bath temperature was then increased to 150° C. for 1 h. A clear solution and a virtually black precipitate formed thereby with evolution of gas and a deep brown discoloration. The reaction is complete when no further evolution of gas is observable. The reaction mixture was stirred for a further 16 h while cooling to room temperature, and the supernatant solution was decanted from the precipitate. 2 ml (1.77 g, 5 mmol) of the dispersant Korantin SH (from BASF) in 50 ml of toluene were added to the remaining residue (Co particles), a completely clear, deep black-brown Co magnetofluid being obtained. It contains 69.20% by weight of Co and 2.21% by weight of Al and has a particle size of 6.15 nm±1.57 nm.

### Example 3

### Co Colloids of Uniform Size (3.5 nm) by Thermolysis of Co₂(CO)₈ in the Presence of Al(CH₃)₃ (Atomic Co:Al ratio=10:1)

A solution of 0.144 g=0.19 ml (2 mmol) of Al(CH₃)₃ in 300 ml of toluene was added to 3.4 g (20 mmol of Co) of solid Co₂(CO)₈ under an inert gas atmosphere (argon) in a 500 ml flask at room temperature. The resulting solution was refluxed for 4 h at 110° C. with stirring (not magnetic stirring), and the bath temperature was then increased to 150° C. for 1 h. A clear solution and a virtually black precipitate formed thereby with evolution of gas and a deep brown discoloration. The reaction is complete when no further evolution of gas is observable. The reaction mixture was stirred for a further 16 h while cooling to room temperature, and the supernatant solution was decanted from the precipitate. 2 ml (1.77 g, 5 mmol) of the dispersant Korantin SH (from BASF) in 50 ml of toluene were added to the remaining residue (Co particles), a completely clear, deep black-brown Co magnetofluid being obtained. It contains 34.50% by weight of Co and 8.44% by weight of Al and has a particle size of 3.5 nm±0.72 nm.

### Example 4

### Co Colloids of Uniform Size (5.4 nm) from Co₂(CO)₈ by Thermolysis in the Presence of Al(C₈H₁₇)₃ (Atomic Co:Al ratio=1:2)

A solution of 15.62 g (42.60 mmol) of Al(C₈H₁₇)₃ in 300 ml of toluene was added to 3.64 g (21.3 mmol of Co) of solid Co₂(CO)₈ under an inert gas atmosphere (argon) in a 500 ml flask at room temperature. The resulting solution was refluxed for 4 h at 130° C. while stirring (not magnetic stirring) and the bath temperature was then increased to 150° C. for 1 h. A clear solution without a precipitate formed thereby with evolution of gas and a deep brown discoloration. The reaction is complete when no further evolution of gas is observable. The reaction mixture was stirred for a further 16 h while cooling to room temperature, and 2 ml (1.77 g, 5 mmol) of the dispersant Korantin SH (from BASF) was added to the resulting solution, a completely clear, deep black-brown Co magnetofluid being obtained. It contains 9.05% by weight of Co and 8.76% by weight of Al; 65.10% by weight of C; 10.18% by weight of H, and has a particle size of 5.4 nm±1.0 nm.

### Example 5

### Fe Colloids of Uniform Size (10.5 nm) from Fe(CO)₅ by Thermolysis in the Presence of Al(C₈H₁₇)₃ (Atomic Fe:Al Ratio=10:1)

0.88 ml (0.73 g, 2 mmol) of Al(C₈H₁₇)₃ were dissolved in 300 ml of toluene under an inert gas atmosphere (argon) in a 500 ml three-necked flask, and 2.7 ml (3.92 g, 20 mmol) of liquid Fe(CO)₅ were then added. The reaction mixture was refluxed for 6 h at 110° C. while stirring (not magnetic stirring) and then the bath temperature was brought first to 130° C. for 1 h and then to 150° C. for a further 1 h. The reaction is complete when no further evolution of gas is observable. After cooling to room temperature, the suspension obtained is further stirred overnight. A dispersion and a virtually black precipitate form with deep brown discoloration. After the solvent had been decanted, the Fe particles were repeptized in toluene by adding the dispersant N-lauroylsarcosine Na salt (Sarcosyl from Merck), and an Fe magnetofluid having long-term stability and a size of 10.5 nm±1.2 nm was obtained.

### Example 6

### Monodisperse Co Colloid (3.4 nm) by Thermolysis of Co(CO)₈ in the Presence of (C₄H₉)₂AlH

2 g of a 50% strength solution of (C₄H₉)₂AlH (7 mmol) in toluene were added to 3.42 g (20 mmol of Co) of solid Co₂(CO)₈ under an inert gas atmosphere (argon) in a 250 ml flask at room temperature. The resulting solution was refluxed for 5 h at 110° C. while stirring (not magnetic stirring). A clear solution and a virtually black precipitate formed thereby with evolution of gas and a deep brown discoloration. The reaction mixture was stirred for a further 16 h while cooling to room temperature, and the supernatant solution was decanted from the precipitate. The reaction is complete when no further evolution of gas is observable. 1 ml (0.89 g, 2.5 mmol) of the dispersant Korantin SH (from BASF) in 30 ml of toluene was added to the remaining residue (Co particle), a completely clear, deep black-brown Co magnetofluid having a size of 3.4 nm±1.3 nm being obtained.

### Example 7

### Comparative Example: Co Colloids by Conventional Method

3 g (17.55 mmol of Co) of solid Co₂(CO)₈ were dissolved in 300 ml of toluene under an inert gas atmosphere (argon) in a 500 ml flask at room temperature with addition of 2 ml (1.77 g, 5 mmol) of the dispersant Korantin SH (from BASF). The resulting solution was refluxed for 4 h at 110° C. while stirring (not magnetic stirring), and the bath temperature was then increased to 150° C. for 1 h. A deep black-brown reaction mixture forms thereby with evolution of gas and discoloration. The reaction is complete when no further evolution of gas is observable. After cooling to room temperature and stirring for a further 16 h, the Co magnetofluid having a broadly scattered Co particle size distribution between 1.8 and 15 nm is obtained (FIG. 1).

### Example 8

### Monodisperse Ni Colloid (2.5 nm) by Thermolysis of Ni(COD)₂ in the Presence of (C₂H₅)₃Al

0.228 g=0.3 ml (2 mmol) of Al(C₂H₅)₃ is added to 0.275 g (1 mmol of Ni) of solid Ni(COD)₂ under an inert gas atmosphere (argon) in a 500 ml flask in 300 ml of toluene at room temperature. The resulting solution is refluxed for 4 h at 110° C. while stirring (not magnetic stirring). A deep brown-black reaction mixture forms thereby. The reaction mixture is stirred for a further 16 h while cooling to room temperature and is freed from all volatile substances in vacuo (10-3 mbar). 2 ml (1.77 g, 5 mmol) of the dispersant Korantin SH (from BASF) in 50 ml of toluene are added to the remaining residue (Ni particles), a deep black-brown Ni magnetofluid having a particle size of 2.5 nm±0.8 nm being obtained.

### Example 9

### Co Colloids of Uniform Size (10 nm) from Co₂(CO)₈ in the Presence of Al(C₈H₁₇)₃ (Atomic Co:Al Ratio=10:1) and Aftertreatment with Air

A solution of 4.4 ml (10 mmol) of Al(C₈H₁₇)₃ in 300 ml of toluene was added to 17.1 g (100 mmol of Co) of solid Co₂(CO)₈ under an inert gas atmosphere (argon) in a 500 ml flask at room temperature (initial Co:Al ratio=10:1). The resulting solution was heated to 110° C. for 18 h while stirring (not magnetic stirring). A clear solution and a virtually black precipitate formed thereby with evolution of gas and a deep brown discoloration. After cooling to 20° C., a further 1.5 ml of Al(C₈H₁₇)₃ were added to the solution. Thereafter, the solution was heated again to 110° C. and kept at 110° C. for 3 h. The reaction mixture was stirred for a further 16 h while cooling to room temperature. The reaction mixture was then oxidized by passing through air (about 5 h) and stirred for about 16 h. The settling of the precipitate over 3 h, the supernatant solution was decanted from the precipitate.

10 ml of a 3% strength solution of the dispersant Korantin SH (from BASF) in toluene were added to 3 g of the dried Co particles, a completely clear, deep black-brown Co magnetofluid being obtained.

### Example 10

### Co Colloids of Uniform Size (8 nm) from Co₂(CO)₈ in the Presence of Al(C₈H₁₇)₃ (Atomic Co:Al Ratio=5:1) and Aftertreatment with Air

8.8 ml (20 mmol) of Al(C₈H₁₇)₃ were dissolved in 300 ml of toluene under an inert gas atmosphere (argon) and introduced into a 500 ml three-necked flask. The solution was heated to 70° C. Thereafter, 17.1 g of solid Co₂(CO)₈ (100 mmol of Co; initial Co:Al ratio=5:1) were added and the reaction mixture was heated to 110° C. The resulting solution was kept at 110° C. for 18 h while stirring (not magnetic stirring). A clear solution and a virtually black precipitate formed thereby with evolution of gas and a deep brown discoloration. After cooling to room temperature, 200 ml of the clear solution were decanted, and a further 1.5 ml of Al(C₈H₁₇)₃, dissolved in 200 ml of toluene, were added to the mixture. The reaction mixture was then heated again to 110° C. and kept at this temperature for 4 h. The reaction mixture was stirred for a further 16 h while cooling to room temperature. The resulting reaction mixture was then oxidized by passing through air (about 5 h) and stirred for about 16 h. After settling of the precipitate over 2 h, the supernatant solution was decanted from the precipitate and the Co particles were washed several times with toluene.

10 ml of a 3% strength solution of the dispersant Korantin SH (from BASF) in toluene were added to 3 g of the dried Co particles, a completely clear, deep black-brown Co magnetofluid being obtained.

1. A process for the preparation of magnetic particles, characterized in that the magnetic particles are produced by decomposition of low-valency compounds of the metals of the magnetic particles in the presence of an organometallic compound of a metal of group 13.

2. The process as claimed in claim 1, the magnetic particles produced having a mean particle size between 3 and 15 nm and a particle size distribution with a standard deviation of not more than 1.6 nm.

3. The process as claimed in claim 1, the mean particle size being established by the nature and concentration of the organomeallic compound used.

4. The process as claimed in claim 1, the organometallic compound used being an organoaluminum compound.

5. The process as claimed in claim 1, the low-valency compounds used being those of iron, of cobalt or of nickel or mixtures thereof.

6. The process as claimed in claim 5, carbonyl compounds of iron, of cobalt or of nickel being used.

7. The process as claimed in claim 5, olefin compounds of iron, of cobalt or of nickel being used.

8. The process as claimed in claim 4, the organoaluminum compound used being an aluminumtrialkyl or an alkylaluminum hydride.

9. The process as claimed in claim 1, the decomposition being effected by thermolysis.

10. The process as claimed in claim 1, the decomposition being effected by photolysis or sonochemically.

11. The process as claimed in claim 1, the magnetic particles produced being protected in an organic solvent by aftertreatment with air.

12. A monometallic or polymetallic magnetic particle having a mean particle size, determined by TEM, of between 2 and 15 nm and a particle size distribution with a standard deviation of not more than 1.6 nm.

13. The magnetic particle as claimed in claim 12, which contains iron, cobalt or nickel.

14. The magnetic particle as claimed in claim 12 or 13, which is protected according to claim 11 by aftertreatment with air.

15. Method of using a magnetic particle as claimed in claim 12 for the preparation of magnetofluids having high saturation magnetization with the aid of dispersants.

16. Method of using the magnetic particle as claimed in claim 12 after application of a cell-compatible coating as a magnetic cell marker.

17. Method of using the magnetic particle as claimed in claim 12 for magnetic cell separation.

18. Method of using the magnetic particle as claimed in claim 12 for magneto-optical information storage.
